(19) United States
(12) Patent Application Publication
(10) Pub. No.: US 2007/0245605 A1
(43) Pub. Date: Oct. 25, 2007

(54) Method of increasing the useful life of a sign or display

(76) Inventors: Richard Allen Hayes, Beaumont, TX (US); David J. Matz, Chadds Ford, PA (US); Thomas R. Phillips, Vienna, WV (US); Lori J. Pike, Newark, DE (US); Rebecca L. Smith, Vienna, WV (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/725,707

(22) Filed: Mar. 19, 2007

Related U.S. Application Data
(60) Provisional application No. 60/783,584, filed on Mar. 17, 2006.

(51) Int. Cl. G09F 13/04

(52) U.S. Cl. 40/541; 40/594

(57) ABSTRACT

A method of improving the useful life of a sign or display is provided. In this method, a sign or display comprising two images and an intervening opaque layer is provided. When the quality of the first of the images to be shown has degraded to an unacceptable degree, the sign or display is reversed to show the second image, which has been at least partially protected from environmental degradation by the intervening opaque layer.

### CROSS-REFERENCE TO RELATED APPLICATION

The present application claims priority under 35 U.S.C. § 120 to U.S. Provisional Appln. No. 60/783,584, filed on Mar. 17, 2006, which is incorporated herein by reference in its entirety.

### FIELD OF THE INVENTION

The invention relates to a method of improving the useful life of signs and other displays. Specifically, a sign or display comprising two images and an intervening opaque layer is provided. When the quality of the first of the images to be shown has degraded to an unacceptable degree, the sign or display is reversed to show the second image, which has been at least partially protected from environmental degradation by the intervening opaque layer.

### BACKGROUND OF THE INVENTION

Several patents and publications are cited in this description in order to more fully describe the state of the art to which this invention pertains. The entire disclosure of each of these patents and publications is incorporated by reference herein.

The useful life of a sign or display is determined in part by how well the image can withstand environmental stresses such as exposure to water, UV light and atmospheric oxygen and ozone. Poor resistance to environmental stresses can result in fading, cracking, peeling, or, in extreme cases, obliteration of the image on the sign or display.

Therefore, methods of increasing the useful life of a sign or display have been developed. Known methods include, for example, choosing more durable materials for the display, such as plastic instead of paper; sealing the surfaces and/or edges of the display so that the penetration of water, oxygen and ozone to the images is reduced; using fade resistant or UV resistant inks to create the images on display; in a similar vein, using only black and white inks to create the images; including a UV filter, such as a coating comprising a UV absorber; using the display in areas of reduced exposure to light, heat or water, such as indoor locations, or shaded locations; and other like strategies.

Using these methods, most signs and displays can be expected to last for several years, perhaps one or two decades. This length of time may be more than adequate for a commercial display, such as, for example, a storefront sign. Such signs are not forbiddingly expensive, and the commercial enterprise may wish to update the information on the sign or modernize its design at intervals roughly corresponding to its useful lifetime.

There are some applications of signs and displays for which a useful life of longer than two decades is desirable, however. Memorials, for example, such as public monuments and private tombstones, are generally expected to be viewed and appreciated for periods of time exceeding 50 years. It is not unusual for a memorial to be on view for several centuries, under very difficult outdoor conditions. Accordingly, the text, figures, and decorations that are associated with memorials are typically carved in stone or cast in metal or concrete. It is apparent that these media and methods demand a considerable investment of time and money in the design and execution of the memorial.

There is a need, therefore, for simple, economical, and effective means of increasing the useful life of signs and other displays. There is a particular need for such techniques in the field of designing and building memorials.

### SUMMARY OF THE INVENTION

According to the present invention, a method of increasing the useful life of signs and other displays is provided. The sign or display is provided with two images and an intervening opaque layer. When the quality of the first of the images to be shown has degraded to an unacceptable degree, the sign or display is reversed to show the second image, which has been at least partially protected from environmental degradation by the intervening opaque layer.

### DETAILED DESCRIPTION

The following definitions apply to the terms as used throughout this specification, unless otherwise limited in specific instances.

The terms “finite amount” and “finite value”, as used herein, refer to an amount that is greater than zero.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such.

The term “or”, as used herein, is inclusive; more specifically, the phrase “A or B” means “A, B, or both A and B”. Exclusive “or” is designated herein by terms such as “either A or B” and “one of A or B”, for example.

In addition, the ranges set forth herein include their endpoints unless expressly stated otherwise. Further, when an amount, concentration, or other value or parameter is given as a range, one or more preferred ranges or a list of upper preferable values and lower preferable values, this is to be understood as specifically disclosing all ranges formed from any pair of any upper range limit or preferred value and any lower range limit or preferred value, regardless of whether such pairs are separately disclosed.

When materials, methods, or machinery are described herein with the term “known to those of skill in the art”, or a synonymous word or phrase, the term signifies that materials, methods, and machinery that are conventional at the time of filing the present application are encompassed by this description. Also encompassed are materials, methods, and machinery that are not presently conventional, but that will have become recognized in the art as suitable for a similar purpose.

“Consisting essentially of” means that the recited components are necessarily present, while smaller amounts of other components may be present to the extent that they do not detract from the operability of the composition. In particular, optional additives as defined herein and minor impurities are not excluded from a composition by the term “consisting essentially of”.

Finally, all percentages, parts, ratios, and the like set forth herein are by weight, unless otherwise stated in specific instances.

The method of the invention improves the useful life of signs and other displays. The terms “sign” and “display” are synonymous herein. The term “useful life”, as used herein, refers to the length of time that the sign or display retains acceptable aesthetic characteristics. Aesthetic characteristics are generally measured qualitatively, that is, according to the viewer's perception. Aesthetic characteristics include, without limitation, the parameters that affect the quality of the image, such as resolution and fading. Fading is of particular importance in the present invention. The perception of whether the aesthetic qualities are acceptable will vary with the viewer's judgment, considering the purpose of the sign or display. For example, a certain amount of fading in a sign over a storefront may be acceptable, especially if the image is large, the graphics are simple, and the viewer is at some distance from the sign. In contrast, a more intimate display, such as decorative safety glass in an architectural barrier, or a memorial bearing information and images relating to an event or a deceased person, typically uses more complicated graphics and is viewed at a closer range. Thus, a more intimate display may be aesthetically unacceptable, although it has been subject to the same amount of fading as a storefront sign.

Briefly, the method of the invention includes providing a display comprising two images, an intervening opaque layer, and an opaque backing. The first image is on view, and the second image is protected by the opaque layer and an opaque backing or structure. When the aesthetic characteristics of the first image are unacceptable, the display is reversed so that the second image is on view, and the first image is protected by the opaque layer and the opaque backing or structure. Again, because the acceptability of the images is judged by a qualitative standard, the viewer may further continue the life of the display by reversing it one or more times, so that each image is on view at least twice. Alternatively, the viewer may continue the life of the display by replacing the images with new copies, revised images, or new images.

The useful life of the sign or display is thus improved by about a factor of two, through use of the methods described herein. The exact value of the improvement factor depends on the extent to which the degradation of the images is caused by environmental factors that can be at least partially mitigated by the intervening opaque layer. Fading due to exposure to light is believed to be the major cause of image degradation that is allayed by the method of the invention. Without wishing to be held to any theory, this type of fading is usually attributed to the interaction of UV light or other high frequency electromagnetic energy with the pigment, substrate, or other components of the sign or display. This interaction causes free radicals to form, and the free radicals initiate chemical reactions that are believed to cause color fading or other image degradation.

Oxidation is another cause of image degradation; however, the exposure of the second image to oxygen and ozone is likely to be the same as that of the first image, whether or not the display is reversed. Heat is also a cause of image degradation. Whether the second image is protected from heat is, in part, a function of the choice of the material for the opaque layer. An opaque layer of an insulating material such as wood or Corian®, for example, will protect the second image from heat more efficiently than will an opaque layer of metal.

The exact length of the useful life of a display depends on many factors, some of which are discussed at greater length below. Briefly, however, the useful life is affected by the materials of which the display is constructed, the choice of ink, the amount of heat and light to which the display is exposed, and the like. In general, however, it is believed that a well-designed and well-constructed display will have a useful life of at least 10 years, preferably at least 20 years, more preferably at least 25 years, and still more preferably at least 50 years. Thus, a two-image display that is reversed according to the method of the invention is expected to have a useful life of at least 20 years, preferably at least 40 years, more preferably at least 50 years, and still more preferably at least 100 years.

The signs and displays used in the method of the invention include an opaque layer. The term “opaque”, as used herein, refers to any material in any thickness, provided that the material selected, in the thickness selected, has a total luminous transmission of less than about 70% as measured by ASTM test method number D 1003. Preferably, the opaque material has a total luminous transmission of less than about 50%, more preferably less than about 30%, still more preferably less than about 10%, and yet more preferably less than about 1% as measured by ASTM test method number D 1003.

The luminous transmission of the opaque layer need not be uniform over its entire area, so long as the portion of the layer that is between the two images is opaque. For example, an image incorporating, surrounded by or partially surrounded by a transparent or translucent field may be desired in a particular design. Thus, a layer in which an opaque portion incorporates, is surrounded by or is partially surrounded by a transparent or translucent portion is considered an “opaque layer”, as the term is used herein, so long as the opaque portion meets the above criteria and is positioned between two images.

The opaque layer may have any color or combination of colors and may be made of any material to which poly vinyl butyral will adhere with or without an adhesive, such as, for example, polymeric resins, glass, composites such as Corian®, wood, metal, concrete or plaster, a metallized polymeric sheet or film, or the like. The opaque layer is preferably a blackout layer, a white film, a white sheet, a white rigid sheet, a frosted glass sheet, an etched glass sheet, or a combination of two or more preferred opaque layers.

For example, a blackout layer having two surfaces with a white film adjacent to each surface is a particularly preferred opaque layer. More specifically, this preferred opaque layer might have the following laminate structure: white opaque layer/additional layer/black opaque layer/additional layer/white opaque layer. Here, the additional layers may be polyvinyl butyral, may be an adhesive, or may be coated on one or both sides with adhesive. Suitable additional layers are described at greater length below.

Suitable blackout layers are commercially available. For example, blackout vinyl is a laminate having a middle layer of black vinyl between two outer layers of vinyl. The black layer prevents light from passing through the laminate. Blackout vinyl has been used for two-sided banners and signs, for example when it is desirable that the banner be viewed from each side without seeing a shadow of the image on the opposite side of the banner.

White films are articles of commerce and encompass a wide variety of compositions and film types and constructions. The white films may be of any composition or construction that will be known to those of skill in the art. While white films are preferred, because they generally provide the greatest contrast with the content of the display, this should not be considered limiting. As is noted above, the opaque layer may have any color that is desired. White films typically range from being translucent to opaque. Polyolefin films with low spectral transmissions are described in, for example, U.S. Pat. Nos. 6,020,116; 6,030,756; 6,071,654; 6,200,740; 6,242,142; and 6,364,997.

Examples of white films and other opaque films usable within the present invention include thermoplastic films with any organic or inorganic dye, pigments or fine particles added thereto; films formed by mixing a film-forming resin component and a resin not miscible (not compatible) with it, and/or organic or inorganic particles, melt kneading the resulting mixture, and stretching it at least in one direction to thereby make the film have fine voids therein; foam films formed through melt extrusion with foaming particles added thereto; and foam films formed through foaming extrusion with a vapor such as carbon dioxide.

The inorganic fine particles used in the white film or other opaque film may or may not have a void forming ability. Examples of suitable inorganic fine particles include fine particles of calcium carbonate, magnesium carbonate, zinc carbonate, titanium oxide, zinc oxide, cerium oxide, magnesium oxide, barium sulfate, zinc sulfate, calcium phosphate, silica, alumina, mica, mica titanium, talc, clay, kaolin, lithium fluoride, calcium fluoride, and the like. These inorganic fine particles may be used independently or in a combination of at least two types. The inorganic fine particles may be solid, hollow, porous or hollow and porous, and may be further subjected to surface treatment for improving dispersibility in a resin, provided that such treatment causes no deterioration in the effect of the present invention. Microbeads, such as polymeric microbeads which may be additionally crosslinked, may also be utilized within the present invention. While not limiting, the particles sizes are generally within the range of about 0.01 to about 10 micrometers, more generally within the range of about 0.05 to about 10 micrometers and most generally from about 0.07 to about 1 micrometer, in the film resin (e.g., polyester) from the viewpoint of uniform dispersibility, and surface glossiness and smoothness of the film. The amount of the fine particles added is preferably 0.1 to 50% by weight, more preferably 2 to 30% by weight, and most preferably 3 to 20% by weight, from the viewpoint of whiteness and a masking property of the film.

The reduction of the total luminous transmission of the white film may also be based on crystallinity of the resin, such as white films produced, for example, from poly(butylene terephthalate), polyacetal, such as poly(oxymethylene), polyamides, such as nylon 6 or 6,6, or crystallized poly(ethylene terephthalate). However, white films generally comprise a thermoplastic resin, generally a polyester, containing inorganic fine particles of titanium oxide, calcium carbonate, barium sulfate, or the like, or a resin incompatible with the polyester or combinations thereof. Additionally, the white film may include voids.

White polyester films are described in, for example, U.S. Pat. Nos. 3,944,699; 4,780,402; 4,898,897; 5,143,765; 5,223,383; 5,281,379; 5,660,931; 5,672,409; 5,888,681; 6,150,012; 6,187,523; 6,440,548; 6,521,351; 6,641,924; 6,645,589; 6,649,250; 6,783,230; 6,869,667; 6,939,600; U.S. Pat. Appln. Publn. Nos. 2002/0136880; 2003/0068466; and 2004/0178139, and European Patent No. 0 942 031.

Fine voids may be incorporated into the white films by a wide variety′ of methods. General methods of forming the fine voids within polyester white films include, without limitation, (1) adding a foaming agent, and forming voids by heating at the time of extrusion or film forming, or by chemical decomposition to form voids; (2) adding a gas or a vaporizable material during extrusion; (3) adding a thermoplastic resin (non-compatible resin) non-compatible (non-miscible) with polyester, and uniaxially or biaxially stretching the polyester to form fine voids; and (4) adding a large amount of inorganic fine particles having a void forming ability instead of the non-compatible (non-miscible) resin. Generally, the method (3) using a non-compatible (non-miscible) resin is more generally utilized from the comprehensive viewpoint of a film forming property, ease of control of the amount of the voids contained in the film, ease of the formation of uniform fine voids, and light weight. The non-compatible resin can generally be any thermoplastic resin which is non-miscible with polyester and preferably disperse in particulate form within the polyester and have a great effect of forming voids in the film during stretching are preferred. More specifically, in a system in which polyester and the non-compatible resin are melted, a glass transition temperature (abbreviated to “Tg” hereinafter) corresponding to the non-compatible resin other than Tg corresponding to the polyester is preferably observed in measurement by a known method, for example, using a differential scanning calorimeter (DSC).

The addition of blue dyes, such as, for example, cobalt blue, ultramarine blue and anthraquinone dyes, such as Sudan Blue 2, may also enhance the whiteness of the film. Generally, the blue dyes would be added at a level of about 10 to about 10,000 ppm based on the weight of the total composition. Preferably, the blue dyes would be added at a level of about 20 to 5,000 ppm based on the total weight of the film composition. More preferably, the blue dyes would be added at a level of about 50 to 1,000 ppm based on the total weight of the film composition. Other colors of dyes may also be used at relatively low levels to “tone” or increase the hiding of the film.

The thickness of the white film is not critical and may be varied depending on the particular application. Generally, the thickness of the white film is about 10 mils (0.25 millimeters (mm)) or less. Preferably, said white film has a thickness of about 0.5 mils (0.012 mm) or about 1 mil (0.025 mm) to about 10 mils (0.25 mm). More preferably, said white film has a thickness of about 1 mil (0.025 mm), to about 5 mils (0.13 mm).

Preferably, one or both surfaces of the white film is treated to enhance the adhesion. This treatment may take any form known within the art, including adhesives, primers, such as silanes, flame treatments, such as disclosed within U.S. Pat. Nos. 2,632,921, 2,648,097, 2,683,894, and 2,704,382, plasma treatments, such as disclosed within U.S. Pat. No. 4,732,814, electron beam treatments, oxidation treatments, corona discharge treatments, chemical treatments, chromic acid treatments, hot air treatments, ozone treatments, ultraviolet light treatments, sand blast treatments, solvent treatments, and the like and combinations thereof. For example, a thin layer of carbon may be deposited on one or both surfaces of the polymeric film through vacuum sputtering as disclosed in U.S. Pat. No. 4,865,711. For example, U.S. Pat. No. 5,415,942 discloses a hydroxy-acrylic hydrosol primer coating that may serve as an adhesion-promoting primer for poly(ethylene terephthalate) films. The polymeric film of the present invention may include a primer coating on one or both surfaces, more preferably both surfaces, comprising a coating of a polyallylamine-based primer. The polyallylamine-based primer and its application to a poly(ethylene terephthalate) polymeric film are disclosed within U.S. Pat. Nos. 5,411,845, 5,770,312, 5,690,994, and 5,698,329.

The white film is preferably sufficiently stress-relieved and shrink-stable under the coating and lamination processes. Preferably, the polymeric film is heat stabilized to provide low shrinkage characteristics when subjected to elevated temperatures (i.e. less than 2 percent shrinkage in both directions after 30 minutes at 150° C.), such are seen through the lamination processes described below. Preferably, the white film is thermally dimensionally stable under typical lamination conditions.

The white films may have modified surfaces. For example, the white films may have coatings of antistatic materials. Examples of the antistatic agent include ionic polymer compounds, surfactants, conductive inorganic fine particles, inorganic electrolytes, organic complex salts, and the like. The term “ionic polymer compounds” is a general term for polymer compounds each having an ionic group in a main chain or side chain, or as a pendant of the main chain. Examples of ionic groups of polymer compounds each having an ionic group include anionic groups of sulfonates, carboxylates, phosphates, alkylsulfonate salts, alkylphosphate salts, and the like; cationic groups of compounds each mainly composed of a tertiary ammonium salt such as an alkyltrimethylammonium salt, lauryl trimethylammonium chloride, an alkylpyrrolidium salt, or the like; nonionic groups of compounds each mainly composed of a polyether, a polyhydric alcohol, a polyoxyethylene alkylamine, a polyoxyethylene fatty acid ester, or the like; long chain fatty acid groups; ampholyte ions of compounds each having tertiary ammonium nitrogen and a carboxyl group or sulfone group; and the like. Examples of a polymer compound having an ionic group in a main chain include polymer compounds each having a pyrrolidium ring, a piperidium ring, or the like in its main chain; and these polymer compounds each further containing, as a comonomer, a compound having an unsaturated bond. Examples of a polymer compound having an ionic group in its side chain include polymer compounds each having a main chain comprising a homopolymer of acrylic acid, methacrylic acid, styrene, or the like and/or a copolymer with another component such as a saturated hydrocarbon such as ethylene, propylene, or the like, an unsaturated hydrocarbon such as acetylene, or the like, or alkylene oxide, and a side chain having an ionic group of a phosphate salt, a sulfonate salt, a vinyl sulfonate salt, a carboxylate salt, a tertiary ammonium salt, or the like.

White films are commercially available. For example, the DuPont Teijin Films Company offers a wide variety of white films under the Melinex® tradename. Other white films are available from the Jindal Polyester Films Company, the PSG Group, and The Oce-Technologies B.V. Company, inter alia.

White sheets for use in the invention can be formed from any suitable material. The sheet has a thickness of greater than about 10 mils (0.25 mm), preferably greater than about 15 mils (0.38 mm), and more preferably greater than about 30 mils (0.75 mm). Some suitable sheets have a thickness of about 100 mils (2.5 mm).

The white sheet is rendered opaque by means that will be known to those of skill in the art, such as for example, printing, inclusion of pigments, inclusion of voids, etc., as described above with respect to white films. Again, while white sheets are preferred, suitable opaque sheets may have any desired color. Preferably, the white sheet is filled with the organic or inorganic particles, as described above for the white film, at the same levels described above for the white film. Sheets having the same opacity as films may be obtained with lower particle levels, however, due to the greater thickness of the sheets. An example of a white sheet is disclosed within U.S. Pat. No. 20050142366. An example of a suitable white sheet that is commercially available is “Coconut White” Butacite® retrim.

A particularly preferable subset of opaque layers are sheets incorporating at least one filler which consists essentially of a composite material obtained from a composition comprising a mineral filler interspersed in a thermoset polymer matrix wherein at least about 80 wt % of the composite filler particles are retained on a number 80 standard sieve. The composite filler material comprises or consists essentially of small particles obtained from solid surface material, such as, for example, Corian®, Wilsonart®, Avonite®, wherein the solid surface material is a composite of a finely divided mineral filler dispersed in a thermoset organic polymer matrix. The composite filler material can optionally include at least one pigment component. The composite filler as used in the practice of the present invention imparts a decorative look to the interlayer and to the laminate obtained from the interlayer. Commonly used mineral fillers used in the solid surface materials include CaCO₃ (calcium carbonate), silica, and alumina. Such mineral fillers can also include oxides such as titanium oxide. A suitable polymer matrix is preferably a thermoset polymer matrix. The thermoset polymer matrix can be obtained from such polymeric materials as acrylic resins, polyester resins, or epoxy resins for example. In a preferred embodiment, the polymeric material that forms the matrix is an alkyl acrylate, wherein the alkyl group comprises from 1 to 6 carbons. In a particularly preferred embodiment, the polymeric matrix is formed from methyl methacrylate. The method of preparing the solid surface material is not critical to the practice of the present invention, however suitable methods are known and described in various publications. For example, a suitable method for preparing a solid surface material is described in U.S. Pat. Pub. 2002/0016399. The solid surface material can additionally optionally comprise pigments, other colorants, or other additives that add to the decorative appearance of the solid surface material.

The composite filler can be obtained from the solid surface material by forming the solid surface material into particles having a suitable size for use in the practice of the present invention. Any conventional method for reducing a larger mass to smaller particles can be used in the practice of the present invention. For example, grinding or pulverizing a solid surface composite polymer into small particles can be suitable in the practice of the present invention. For practical considerations, the size of the filler particles is limited by the size of particle that can pass through the processing equipment. Removal of particulate filters from extrusion equipment can facilitate the process described herein.

Careful selection and/or manipulation of the particle size of the composite fillers can control the clarity and diffusive power of the sheet and the resulting laminates. The particle size of the composite filler can be controlled by conventional methods such as use of an appropriately sized sieve. Alternatively, the desired size of particle can be obtained from commercial manufacturers of the composite filler. Preferably, particles of composite filler suitable for use herein have an average particle size such that at least about 80 wt % of the particles are retained on a number 80 standard sieve. Preferably at least about 85 wt % of the composite filler particles are retained on a No. 80 sieve. More preferably at least about 90 wt % of the composite filler is retained on a No. 80 sieve. In a particularly preferred embodiment, at least about 65 wt % of the composite filler particles pass through a No.12 U.S. Standard sieve. In another particularly preferred embodiment of the present invention, 100 wt % of the composite filler particles pass through a No.12 U.S. Standard sieve.

The concentration of the composite filler is selected such that the desirable decorative effect is obtained while obtaining light transmission that is suitable and appropriate for the intended application. In general, the concentration of the composite filler is approximately the same as that of the more general category of fillers described above.

Commercially available composite fillers from the DuPont Company include, for example; composite filler KJ (ground Corian® having a mixture of particles, characterized in that 65 wt % passes through a No. 12 U.S. standard sieve) and a ground Corian® SM-type filler, (100 wt % of the particles pass through a No.12 U.S. standard sieve).

In a preferred embodiment, the opaque layer incorporates an opaque rigid sheet. The opaque rigid sheet comprises a material with a modulus of greater than about 20,000 psi (138 MPa), as measured by ASTM Method D-638. Preferably, the opaque rigid sheet comprises a material with a modulus of about 25,000 psi (173 MPa), or greater as measured by ASTM Method D-638. More preferably, the rigid sheet comprises a material with a modulus of about 30,000 psi (207 MPa), or greater as measured by ASTM Method D-638. Preferably, the rigid sheet comprises a polyester, such as poly(ethylene terephthalate, poly(butylene terephthalate, poly(1,3-propylene terephthalate), poly(ethylene naphthalate), PETG, and the like; a polyamide, such as nylon 6, nylon 6,6, and the like; a polycarbonate, such as Lexan®; a cyclic olefin copolymer; an ethylene copolymer, such as ethylene copolymers which incorporate from about 1 to 30 weight percent alpha, beta-ethylenically unsaturated carboxylic acids and ionomer derived therefrom; a composite, such as Corian®; a frosted and/or etched glass sheet, and the like. The opaque rigid sheet can have the same thickness as described for the white sheet. The surfaces of the rigid sheet may be treated to enhance adhesion and other properties, as described above for the white film and the white sheet.

A sign or display suitable for use in the invention includes two images, one on each side of the opaque layer. In a sign suitable for use in the present invention, the two-images may be imprinted directly on the two surfaces of the opaque layer. The two images may be the same or different. In some preferred embodiments, they may be related as mirror images. The images may include, for example, a mark, a picture, a symbol, a geometric pattern, a photograph, an alphanumeric character, or the like and combinations thereof.

Methods of imprinting images on the opaque layer materials, and indeed on all of the layer materials described herein, will be familiar to those of skill in the art. In this connection, the term “imprinting” as used herein refers to any means of creating an image on a surface.

Suitable methods of imprinting include, but are not limited to, writing, air-knife, painting, Dahlgren, spraying, thermal transfer printing, silk screen, lithography, flexographic, gravure and ink jet printing, dye sublimation, xerography, screen printing, letterpress and the like. Preferred methods of imprinting include ink jet printing, dye sublimation printing, and thermal transfer printing. Other suitable methods are set forth in International Patent Appln. Publn. Nos. WO200218154, WO200401127, and WO2004018197. An image may be printed on the surface of the layer that is closest to the viewer. Alternatively, an image may be “reverse printed”, that is, printed on the surface of the layer that is opposite from the viewer.

As used herein, the term “ink” refers to any substance capable of creating an image on a surface. Inks, therefore, include, but are not limited to, graphite, pigments, dyes, inks, paints, and the like. Pigment-based inks are preferred, because of their relatively good resistance to degradation by environmental factors such as light, oxygen, and heat.

Preferred signs for use in the method of the invention include laminates comprising an opaque layer. The two images may be imprinted directly onto the opposite surfaces of the opaque layer. Alternatively, the images may be imprinted on other layers that are laminated, directly or indirectly, to the opaque layer.

Thus, suitable signs may comprise at least one additional layer, which may be a film, a sheet, or a coating on a film or a sheet. The additional layer may be an image-bearing and/or colored layer, or it may be a layer without an image and/or a color. When the additional layer is a sheet, it may be a rigid or a flexible sheet.

In this connection, different physical properties are often desired from films and sheets. For example, a sheet may be required to be self-supporting, or a film may require more resistance to puncture or tearing. Accordingly, in the additional layers as in the image-bearing layers, different polymeric resins are preferred for use at different thicknesses.

Examples of suitable materials for additional layers that are polymeric sheets include materials with a modulus of 20,000 psi (138MPa), or less as measured by ASTM Method D-638 or greater than 20,000 psi. Said “additional layer” polymeric film and sheets may provide additional attributes, such as acoustical barriers. Polymeric films and sheets which provide acoustical dampening include, for example, ethylene vinyl acetate copolymers, ethylene methyl acrylate copolymers, plasticized polyvinyl chloride resins, metallocene-catalyzed polyethylene compositions, polyurethanes, polyvinyl butyral compositions, highly plasticized polyvinyl butyral compositions, silicone/acrylate (“ISD”) resins, and the like. Such “acoustic barrier” resins are disclosed within, for example, U.S. Pat. Nos. 5,368,917, 5,624,763, 5,773,102, and 6,432,522.

Preferably, said “additional layers” polymeric film or sheet is selected from the group consisting of polycarbonate, polyurethane, acrylic sheets, polymethylmethacrylate, polyvinyl chloride, polyester, poly(ethylene-co-(meth)acrylic acid) ionomers and biaxially oriented poly(ethylene terephthalate), polystyrene, polystyrene-butadiene copolymer, and possibly nylon and the like. Said polymeric films and sheets may additionally have functional coatings applied to them, such as UV absorbers, organic infrared absorbers and sputtered metal layers, such as silver, coatings and the like. Metal coated polymeric films and sheets are disclosed in, for example, U.S. Pat. Nos. 3,718,535; 3,816,201; 4,465,736; 4,450,201; 4,799,745; 4,846,949; 4,954,383; 4,973,511; 5,071,206; 5,306,547; 6,049,419; 6,104,530; 6,204,480; 6,255,031 and 6,565,982. Adhesives or primers may be included, especially to provide adequate adhesion between the other polymeric layer and the interlayer of the present invention.

Preferred films for use as additional film layers include, without limitation, oriented and unoriented polyester films, polycarbonate films, polyurethane films, polyvinyl chloride films, and the like. Preferably, the additional film layer is biaxially oriented poly(ethylene terephthalate). Preferred sheets for use as additional sheet layers include, without limitation, sheets comprising polyvinyl butyral compositions, ethylene vinyl acetate compositions, thermoplastic polyurethane compositions, polyvinyl chloride copolymer compositions, ethylene acid copolymer compositions and ionomers derived therefrom, and the like.

Preferred rigid sheets for use as additional layers include glass, for example. The term “glass” as used herein includes window glass, plate glass, silicate glass, sheet glass, float glass, colored glass, specialty glass which may, for example, include ingredients to control solar heating, glass coated with sputtered metals such as silver, for example, glass coated with ATO and/or ITO, E-glass, Solex™ glass (available from PPG Industries of Pittsburgh, PA), Toroglass™, and the like. A typical glass type is 90 mil thick annealed flat glass, and it is preferable to orient the tin side of the glass to the interlayer to achieve optimal adhesion. Alternatively, the rigid sheet may be a rigid polymeric sheet, such as, for example, polycarbonate, acrylics, polyacrylate, cyclic polyolefins, such as ethylene norbornene polymers, metallocene-catalyzed polystyrene, and the like, and mixtures or combinations thereof. Preferably, the rigid sheet is transparent when it serves as an additional layer.

The additional layer(s) may also have functional coatings applied to them, such as a coating comprising a UV absorber. Those of skill in the art are aware that any treatments, hard coats, adhesives, and primers that are familiar to those of skill in the art may also be applied to the additional layer(s), as dictated by the desired construction of the sign and the process efficiencies.

In this connection, those of skill in the art are also aware that ink typically does not adhere to rigid sheet materials. Likewise, polyester films typically do not adhere to rigid sheets. Therefore, additional layers, typically polyvinyl butyral layers, may be interleaved between image bearing surfaces and rigid sheets, or between films and rigid sheets. As noted above, adhesives and primers may be used in place of or in conjunction with this interleaving, where appropriate.

Preferred signs and displays include laminated structures comprising adjacent layers as follows:
first rigid sheet/first additional layer/first image bearing sheet/opaque layer/second image bearing sheet/second additional layer/second rigid sheet; and
first rigid sheet/first additional layer/first image bearing film/second additional layer/opaque layer/third additional layer/second image bearing film/fourth additional layer/second rigid layer.

A specific example of a preferred laminated structure in which the image bearing layers are reverse printed is:
first rigid sheet/first image bearing film/additional layer/opaque layer/second additional layer/second image bearing film/second rigid sheet.

In each of the above embodiments, “/” indicates adjacent layers. Moreover, the “second” layer of any film or sheet may be the same as or different from the first layer of that film or sheet. Likewise, the “third” layer may be the same as or different from the first and second layers of that film or sheet, and so on. Furthermore, in some preferred embodiments of the invention, the adjacent layers are laminated directly to each other so that they are adjoining or, more preferably, contiguous in the laminate structure.

Any suitable process may be used to produce the laminated displays. Those of skill in the art are aware that different processes and conditions may be desirable, depending on the composition of the layers in the display, and on whether a rigid or flexible laminate is desired.

For example, one or more polymeric sheets and an opaque layer may be bonded to each other and/or to one or more additional layers in a nip roll process. In such a process, the additional layer(s) are fed along with the opaque layer through one or more calendar roll nips in which the layers are subjected to moderate pressure and, as a result, form a weakly bonded laminate. Generally, the bonding pressure will be within the range of about 10 psi (0.7 kg/cm²) to about 75 psi (5.3 kg/cm²), and preferably it is within the range of about 25 psi (1.8 kg/cm²) to about 30 psi (2.1kg/cm²). Typical line speeds are within the range of about 5 feet (1.5 m) to about 30 feet (9.2 m) per minute. The nip roll process may be conducted with or without moderate heating, which may be supplied by an oven or by a heated roll, for example. When heated, the polymer surfaces should achieve a temperature sufficient to promote temporary fusion bonding, that is, to cause the surfaces of the polymeric sheet or film to become tacky. Suitable surface temperatures for the preferred polymeric films and sheets are within the range of about 50° C. to about 120° C., and preferably the surface temperature is about 65° C. After fusion bonding, the laminate may be passed over one or more cooling rolls to ensure that the laminate is sufficiently strong and not tacky when taken up for storage. Process water cooling is generally sufficient to achieve this objective.

In another typical procedure to make a laminate, an interlayer comprising an opaque layer and two polymeric sheets is positioned between two glass plates to form a glass/interlayer/glass pre-press assembly. Preferably, the glass plates have been washed and dried. Air is drawn out from between the layers of the pre-press assembly using a vacuum bag (see, for example, U.S. Pat. No. 3,311,517), a vacuum ring, or another apparatus capable of maintaining a vacuum of approximately 27 to 28 inches (689 to 711 mm Hg). The pre-press assembly is sealed under vacuum, then placed into an autoclave for heating under pressure. With increasing order in the preference given, the temperature in the autoclave is from about 130° C. to about 180° C., from about 120° C. to about 160° C., from about 135° C. to about 160° C., or from about 145° C. to about 155° C. The pressure in the autoclave is preferably about 200 psi (15 bar). With increasing order in the preference given, the pre-press assembly is heated in the autoclave for about 10 to about 50minutes, about 20 to about 45 minutes, about 20 to about 40 minutes, or about 25 to about 35 minutes. Following the heat and pressure cycle, the air in the autoclave is cooled without adding additional gas to maintain pressure in the autoclave. After about 20 minutes of cooling, the excess air pressure is vented and the laminates are removed from the autoclave.

Alternatively, a nip roll process may be used to produce laminated displays. In one such process, the glass/interlayer/glass assembly is heated in an oven at or to between about 80° C. and about 120° C., preferably between about 90° C. and about 100° C., for about 30 minutes. Thereafter, the heated glass/interlayer/glass assembly is passed through a set of nip rolls so that the air in the void spaces between the glass and the interlayer is expelled. The edges of the structure are sealed at this point to produce a pre-press assembly that may be processed under vacuum in an autoclave, as described above, to produce a finished laminate.

Laminated displays may also be produced by non-autoclave processes. Several suitable non-autoclave processes are described in U.S. Pat. Nos. 3,234,062; 3,852,136; 4,341,576; 4,385,951; 4,398,979; 5,536,347; 5,853,516; 6,342,116; 5,415,909; in U.S. Pat. Appln. Publn. No. 2004/0182493; in European Patent No. 1 235 683 B1; and in International Patent Appln. Publn. Nos. WO 91/01880 and WO 03/057478A1, for example. Generally, non-autoclave processes include heating the pre-press assembly and the application of vacuum, pressure or both. For example, the pre-press assembly may be passed through heating ovens and nip rolls.

When the sign is a laminate, at least the surfaces bearing the images are preferably treated with an adhesive or primer, because inks do not readily adhere to many other materials. Adhesives or primer treatments may be used elsewhere throughout the laminate, as necessary or appropriate. The treatment is preferably a coating, which may be a partial or complete. Suitable adhesives and primers will be known to those of skill in the art. Preferably, said adhesive or primer is a silane incorporating an amine function. Specific examples of such materials include, for example; gamma-aminopropyltriethoxysilane, N-beta-(aminoethyl)-gamma-aminopropyl-trimethoxysilane, and the like and mixtures thereof. Commercial examples of such materials include, for example A-1100™ silane (from the Silquest Company, formerly from the Union Carbide Company, believed to be gamma-aminopropyl trimethoxysilane) and Z6020™ silane (from the Dow Company).

The adhesives may be applied through melt processes or through solution, emulsion, dispersion, and like coating processes. One of ordinary skill in the art will be able to identify appropriate process parameters based on the composition and process used for the coating formation.

The method of the invention is useful for any application in which it is desirable that the useful life of a sign or display be prolonged. These applications include signs; memorials; any application that is set forth in International Patent Appln. Publn. Nos. WO200218154, WO200401127, or WO2004018197; and the like.

Of particular interest are backlit displays. In constructing a backlit display, an opaque layer that is translucent enough to pass light relatively uniformly should be selected. If both images in the display were the same, however, the back side image may be visible as a shadow when the display is viewed from the front side. If the two images were printed as mirror images of each other, the shadow effect could be significantly reduced or completely eliminated. To preserve the benefits of the invention, the lighting source for the backlighting should be relatively gentle, for example, of relatively low intensity or emitting relatively little UV or higher frequency radiation.

The two images and the intervening opaque layer are reversibly attached to an opaque backing or to an opaque structure. The opaque backing or structure may be any type of structure, such as a board, a slab, a fence, a partition or a memorial, for example. The opaque structure may be free standing, or it may be a portion of another structure, such as an inner or outer wall of a building.

Those of skill in the art are familiar with means of mounting signs and displays that are useful in the methods of the present invention. For example, a simple banner may be hung with nails, screws or hooks against a wall. A laminated glass display may also be hung against an opaque structure, framed or unframed. In another application, the display may be mounted in a freestanding structure, such as a tombstone having an opaque backing. In a preferred embodiment, the opaque structure is equipped with a recess that is suitably sized to receive the sign or other display. Brackets or other means of temporarily securing the sign or display may also be used.

The materials from which the opaque structure or backing may be made include, without limitation, wood, stone, polymeric resins, glass, composites of polymers with wood or minerals, plaster, concrete, and metals.

Analogously to the opaque layer, the luminous transmission of the opaque backing or structure need not be uniform over its entire area, so long as the portion of the structure that shields the second image from light is opaque.

The utility of the present invention may be increased by taking additional measures to increase the useful life of the first and/or second image. Strategies for increasing resistance to fading include, for example, sealing the surfaces and/or edges of the display so that the penetration of oxygen and ozone to the images is reduced; using fade resistant or UV resistant inks to create the images; in a similar vein, using only black and white inks to create the images; including a UV filtering layer, such as a coating comprising a UV absorber, in a laminated display; using the display in areas of reduced light or heat exposure, such as indoor locations, or shaded locations; and like strategies, and combinations of two or more of these approaches.

The following example is provided to describe the invention in further detail. This example, which sets forth a preferred mode presently contemplated for carrying out the invention, is intended to illustrate and not to limit the invention.

### EXAMPLE

An ink set includes the following ink formulations; Magenta (36.08weight percent of a magenta pigment dispersion (7 weight percent pigment), 38.35 weight percent Dowanol® DPMA (a product of the Dow Company), and 25.57 weight percent Dowanol® DPnP (a product of the Dow Company), (based on the total weight of the ink formulation); Yellow (35.23 weight percent of a yellow pigment dispersion (7 weight percent pigment), 38.86 weight percent Dowanol® DPMA, and 25.91 weight percent Dowanol® DPnP, (based on the total weight of the ink formulation); Cyan (28.35 weight percent of a cyan pigment dispersion (5.5 weight percent pigment), 42.99 weight percent Dowanol® DPMA, and 28.66 weight percent Dowanol® DPM (a product of the Dow Company), (based on the total weight of the ink formulation); and Black (27.43 weight percent of a black pigment dispersion (7 weight percent pigment), 43.54weight percent Dowanol® DPMA, and 29.03 weight percent Dowanol® DPM, (based on the total weight of the ink formulation). The pigment dispersion compositions and preparations are as disclosed within the Example section of U.S. Pat. Nos. 2004/0187732.

Using this ink set, a 30 mil thick (0.75 mm) Butacite® poly(vinyl butyral) sheet (a product of the DuPont Company) is ink jet printed with a decoration using an Epson 3000 printer to provide a ink coverage of 25 percent.

A solution of A-1100 silane (0.05 weight percent based on the total weight of the solution, a product of the Silquest Company, believed to be gamma-aminopropyltrimethoxysilane), isopropanol (66.63 weight percent based on the total weight of the solution), and water (33.32 weight percent based on the total weight of the solution), is prepared and allowed to rest at room temperature for at least one hour prior to use. The two 12-inch by 12-inch pieces of the decorated Butacite® sheet are dipped into the silane solution (residence time of about 1 minute), removed and allowed to drain and dry under ambient conditions. Two 12-inch by 12-inch pieces of an undecorated Butacite® sheet are also dipped into the silane solution (residence time of about 1 minute), removed and allowed to drain and dry under ambient conditions.

A glass laminate composed of a glass layer, the first silane primed decorated Butacite® polymeric interlayer from above, a white film layer, the second silane primed decorated Butacite® polymeric interlayer from above and a glass layer is produced in the following manner. The first primed decorated Butacite® sheet (12 inches by 12 inches (305 mm×305 mm)), a Melinex® 329 white film (12 inches by 12 inches (305 mm×305 mm) by 5 mils thick (0.13 mm), a commercial product of the DuPont Teijin Films Company), and the second silane primed decorated Butacite® polymeric interlayer from above (12 inches by 12 inches (305 mm ×305 mm) by 15 mils thick (0.38 mm)), and the two undecorated Butacite® sheets (12 inches by 12 inches (305 mm×305 mm)) are conditioned at 23 percent relative humidity, (RH), at a temperature of 72 degrees F overnight. The sample is laid up with a clear annealed float glass plate layer, (12 inches by 12 inches (305 mm×305 mm) by 2.5 mm thick), the first primed undecorated Butacite® sheet layer, the first primed decorated Butacite® sheet layer (image facing towards the adjacent undecorated sheet), the Melinex® 329 white film layer, the second primed decorated Butacite® sheet layer (image facing towards the adjacent undecorated sheet), the second primed undecorated Butacite® sheet layer and a clear annealed float glass plate layer, (12 inches by 12 inches (305 mm×305 mm) by 2.5 mm thick).

The glass/interlayer/glass assembly is then placed into a vacuum bag and heated to 90-100° C. for 30 minutes to remove any air contained between the glass/interlayer/glass assembly. The glass/interlayer/glass pre-press assembly is then subjected to autoclaving at 135° C. for 30 minutes in an air autoclave to a pressure of 200 psig, (14.3 bar). The air is then cooled while no more air is added to the autoclave. After 20 minutes of cooling when the air temperature is less than about 50° C., the excess pressure is vented, and the glass/interlayer/glass laminate is removed from the autoclave.

The laminate is mounted such that the first decorated sheet is visible through the glass, but the second decorated sheet is hidden from view by the white film layer. The mounted laminate is used as a memorial in an outdoor display. After a period of time, the image quality of the first decorated sheet is unacceptably degraded because of exposure to environmental factors such as UV light, for example. The laminate is taken out of the mounting and reversed, so that the second decorated sheet is visible through the glass, and the first decorated sheet is hidden from view by the white film layer. The useful life of the memorial is increased by a factor of approximately two, that is, until the image quality of the second decorated sheet is also unacceptably degraded.

While certain of the preferred embodiments of the present invention have been described and specifically exemplified above, it is not intended that the invention be limited to such embodiments. Various modifications may be made without departing from the scope and spirit of the present invention, as set forth in the following claims.

What is claimed is:

1. A method of increasing the useful life of a sign or other display, said method comprising:
displaying the sign or other display, said sign or other display comprising:
(a) a first image on view,
(b) an intervening opaque layer, and
(c) a second image protected by the intervening opaque layer and by an opaque backing or structure,
wherein the first image on view is adhered to a first side of the intervening opaque layer, a second side of the intervening opaque layer is adhered to the second image,
the second image is adjacent to the opaque backing or structure;
allowing environmental degradation of the first image until one or more of the aesthetic characteristics of the first image are unacceptable;
reversing the sign or other display so that the second image is on view and the first image is protected by the intervening opaque layer and the opaque backing or structure; and
displaying the reversed sign or other display.

2. The method of claim 1, wherein the opaque backing or structure is freestanding.

3. The method of claim 1, wherein the opaque backing or structure is a portion of another structure.

4. The method of claim 1, wherein the opaque backing or structure comprises a board, a slab, a fence, a partition, a building, a wall or a memorial.

5. The method of claim 1, wherein the opaque backing or structure comprises one or more of wood, stone, a polymeric resin, glass, a composite of a polymeric resin with wood or with one or more minerals, plaster, concrete, or a metal.

6. The method of claim 1, wherein the sign or other display is reversibly attached to the opaque backing or structure by means comprising a nail, a screw, a hook, a frame, a recess that is suitably sized to receive the sign or other display, or a bracket.

7. The method of claim 1, wherein the opaque backing or structure has a luminous transmission that is not uniform over the area of the opaque backing or structure.

8. The method of claim 1, wherein the intervening opaque layer comprises one or more of a polymeric resin, glass, a composite, wood, metal, concrete, plaster, a metallized polymeric sheet or a metallized polymeric film.

9. The method of claim 1, wherein the intervening opaque layer comprises one or more of a blackout layer, a white film, a white sheet, a white rigid sheet, a frosted glass sheet, or an etched glass sheet.

10. The method of claim 1, wherein the intervening opaque layer comprises a sheet comprising at least one filler, said at least one filler consisting essentially of a composite material obtained from a composition comprising a mineral filler interspersed in a thermoset polymer matrix.

11. The method of claim 1, wherein the intervening opaque layer has the structure: first white opaque layer/first additional layer/black opaque layer/second additional layer/second white opaque layer, wherein “/” indicates adjacent layers and wherein the films and sheets in a structure are selected independently and may be the same as or different from other films or sheets in the structure.

12. The method of claim 11, wherein one or both of the additional layers comprises poly vinyl butyral.

13. The method of claim 1, wherein the intervening opaque layer has a luminous transmission that is not uniform over the area of the intervening opaque layer.

14. The method of claim 1, wherein the first image or the second image is imprinted directly on one or both surfaces of the opaque layer.

15. The method of claim 1, wherein the first image and the second image are related as mirror images.

16. The method of claim 1, wherein the first image or the second image is imprinted by one or more of writing, air-knife, painting, Dahlgren, spraying, thermal transfer printing, silk screen, lithography, flexographic, gravure and ink jet printing, dye sublimation, xerography, screen printing, or letterpress.

17. The method of claim 1, wherein the first image or the second image is reverse printed.

18. The method of claim 1, wherein the sign or other display is a laminate comprising an opaque layer and at least one additional layer.

19. The method of claim 18, wherein the first image or the second image is imprinted on one or more additional layers that are laminated, directly or indirectly, to the opaque layer.

20. The method of claim 19, wherein at least one of the one or more additional layers is an acoustical barrier layer comprising one or more of an ethylene vinyl acetate copolymer, an ethylene methyl acrylate copolymer, a plasticized polyvinyl chloride resin, a metallocene-catalyzed polyethylene composition, a polyurethane, a polyvinyl butyral composition, a highly plasticized polyvinyl butyral composition, or a silicone/acrylate resin.

21. The method of claim 19, wherein at least one of the one or more additional layers comprises a material selected from the group consisting of polycarbonate, polyurethane, acrylic sheet, polymethylmethacrylate, polyvinyl chloride, polyester, poly(ethylene-co-(meth)acrylic acid) ionomers and biaxially oriented poly(ethylene terephthalate), polystyrene, polystyrene-butadiene copolymer, and nylon.

22. The method of claim 19, wherein at least one of the one or more additional layers is at least partially coated with one or more functional coatings selected from the group consisting of UV absorbers, organic infrared absorbers and sputtered metal layers, hard coats, adhesives and primers.

23. The method of claim 19, wherein at least one of the one or more additional layers is a film selected from the group consisting of oriented and unoriented polyester films, polycarbonate films, polyurethane films, and polyvinyl chloride films or a sheet comprising one or more compositions selected from the group consisting of polyvinyl butyral compositions, ethylene vinyl acetate compositions, thermoplastic polyurethane compositions, polyvinyl chloride copolymer compositions, ethylene acid copolymer compositions and ionomers derived from ethylene acid copolymer compositions.

24. The method of claim 19, wherein at least one of the one or more additional layers is a rigid sheet comprising one or more materials selected from the group consisting of window glass, plate glass, silicate glass, sheet glass, float glass, colored glass, specialty glass that includes ingredients that control solar heating, glass coated with one or more sputtered metals, glass coated with ATO or ITO, E-glass, Solex ™ glass, Toroglass™, polycarbonate, acrylics, polyacrylate, cyclic polyolefins, and metallocene-catalyzed polystyrene.

25. The method of claim 1, wherein the sign or other display comprises a laminated structure comprising adjacent layers as follows:
first rigid sheet/first additional layer/first image bearing sheet/opaque layer/second image bearing sheet/second additional layer/second rigid sheet; or
first rigid sheet/first additional layer/first image bearing film/second additional layer/opaque layer/third additional layer/second image bearing film/fourth additional layer/second rigid layer;
wherein “/” indicates adjacent layers and wherein the films and sheets in a structure are selected independently and may be the same as or different from other films or sheets in the structure.

26. The method of claim 17, wherein the sign or other display comprises a laminated structure comprising adjacent layers as follows:
first rigid sheet/first image bearing film/additional layer/opaque layer/second additional layer/second image bearing film/second rigid sheet;
wherein “/” indicates adjacent layers and wherein the films and sheets in a structure are selected independently and may be the same as or different from other films or sheets in the structure.

27. The method of claim 1, wherein the sign or other display is backlit.

28. The method of claim 1, further comprising the step of taking one or more additional measures to increase the useful life of the first and/or second image, said one or more additional measures selected from the group consisting of: sealing the surfaces or edges of the display so that the penetration of oxygen and ozone to the images is reduced; using fade resistant or UV resistant inks to create the images; using only black and white inks to create the images; including a UV filtering layer in a laminated display; and using the display in areas of reduced light or heat exposure.

29. A method of increasing the useful life of signs and other displays comprising the step of preparing a sign or display with two images, wherein the two images may be identical images, mirror images, or different images; displaying the sign or display so that the first of the two images is on display and the second of the two images is hidden from display and at least partially shielded from light exposure; and, when the first of the two images has degraded past its useful life, switching the images so that the second of the two images is displayed.
